(19) United States
(12) Patent Application Publication
(10) Pub. No.: US 2008/0197094 A1
(43) Pub. Date: Aug. 21, 2008

(54) Aerial lift including a stowable jim boom and stowable work platform

(76) Inventor: Anthony E. Bond, Omaha, NE (US)

Correspondence Address: THOMTE LAW OFFICE, L.L.C., 2120 S. 72ND STREET, SUITE 1111, OMAHA, NE, 68124, US

(21) Appl. No.: 12/009,481

(22) Filed: Jan. 18, 2008

Related U.S. Application Data
(60) Provisional application No. 60/902,186, filed on Feb. 20, 2007.

(51) Int. Cl. B66C 23/42

(52) U.S. Cl. 212/300

(57) ABSTRACT

An aerial lift is provided which includes a stowable jib boom and a stowable work platform. The stowable jib boom may be stowed at one side of the main boom and the work platform may be stowed at the other side of the main boom. The jib boom is easily brought into position through the use of a mounting apparatus on the outer end of the innermost boom section of the boom assembly. The work platform may also be moved between its stowed and working positions through the use of the mounting apparatus on the outer end of the inner boom section.

### CROSS REFERENCE TO RELATED APPLICATION

This Application claims the benefit of Provisional Application No. 60/902,186 filed on Feb. 20, 2007 entitled AERIAL LIFT INCLUDING A STOWABLE JIM BOOM AND STOWABLE WORK PLATFORM.

### BACKGROUND OF THE INVENTION

1. Field of the Invention

This invention relates to an aerial lift including a stowable jib boom and stowable work platform and more particularly to an aerial lift wherein the jib boom may be stowed adjacent one side of the main boom when not in use and wherein the work platform may be disconnected from the outer end of the main boom and positioned in a stowed position adjacent the other side of the main boom. When the work platform is in its stowed position, the jib boom may be extended from the outer end of the main boom. The outer end of the jib boom may have a cable sheave mounted thereon or may have a second work platform secured thereto.

2. Description of the Related Art

Many types of aerial lifts including a telescoping boom assembly have been previously provided. Many of those prior art aerial lifts include a personnel carrier bucket, basket or work platform mounted on the outer end of the innermost section of the main boom. Prior to the invention in U.S. Pat. No. 5,727,645, which is owned by the assignee of this invention, it is believed that the prior art aerial lifts did not have an end-hung basket mounted thereon which could be quickly and easily mounted on the boom assembly and which could be quickly and easily disconnected therefrom. In the device of U.S. Pat. No. 5,727,645, an end-hung basket was provided which could be quickly attached to the boom assembly and quickly detached therefrom. However, in the invention of U.S. Pat. No. 5,727,645, and in the other aerial lifts of which applicant is aware, when the work platform is removed from the boom assembly, the work platform must normally be stowed or positioned on the ground. If the aerial lift is moved to another location, the work platform would either have to be transported to a different location on a truck or the like or reconnected to the main boom assembly for transport therewith. Further, to the best of applicant's knowledge, it is not believed that any of the prior art devices had a convenient means for stowing a jib boom at one side of the main boom. Those jib boom assemblies of which applicant is aware and which could be stowed adjacent one side of the main boom assembly required considerable effort and manual labor to disconnect the jib boom from the main boom and to reconnect the same.

### SUMMARY OF THE INVENTION

An aerial lift is provided which is mounted on a self-propelled vehicle such as a truck or the like having rearward and forward ends. A pedestal is rotatably mounted, about a vertical axis, on the vehicle. A telescoping boom assembly including an elongated outer boom with at least one elongated inner boom section telescopically received thereby extends outwardly from the pedestal. The outer boom section has first and second sides, an inner end and an outer end with the inner boom section having an inner end and an outer end. A first mounting apparatus is provided on the outer end of the inner boom section with the first mounting apparatus being pivotally movable about a first horizontal axis transverse to the longitudinal axis of the inner boom section. The first mounting apparatus is also pivotally movable about a second axis which is disposed transversely with respect to the first axis.

A work platform is selectively removably secured to the first mounting apparatus for movement therewith. An elongated jib boom, having inner and outer ends, is selectively removably positioned and secured in a stowed position at the first side of the outer boom, with the inner end thereof being positioned adjacent the outer end of the outer boom section and the outer end of the jib boom being positioned forwardly of the inner end thereof when in the stowed position. The inner end of the jib boom is adapted to be selectively secured to the first mounting apparatus. The first mounting apparatus is selectively movable with respect to the inner boom section to permit the first work platform to be positioned at the second side of the outer boom section whereby the first work platform may be disconnected from the first mounting apparatus, moved towards said inner end of said outer boom section and stowed at the second side of the outer boom section. The first mounting apparatus is also selectively movable with respect to the inner boom section to permit the first mounting apparatus to be positioned adjacent the inner end of the jib boom, when the jib boom is in its stowed position, for connection therewith whereby the jib boom may be pivotally moved from its stowed position so as to be extended from the outer end of the inner boom section. Preferably, the outer end of the jib boom has means associated therewith for connection to a second work platform.

It is therefore a principal object of the invention to provide an improved aerial lift.

A further object of the invention is to provide an aerial lift which includes a stowable jib boom and a stowable work platform.

Yet another object of the invention is to provide an aerial lift wherein the work platform, which is normally secured to the outer end of the main boom, may be stowed at one side thereof when not being used.

Still another object of the invention is to provide an aerial lift which enables a stowed jib boom to be easily connected to the outer end of the main boom assembly.

Still another object of the invention is to provide an aerial lift which enables a work platform to be quickly and easily connected to the outer end of a main boom assembly and easily and quickly disconnected therefrom and stowed at one side of the main boom assembly.

These and other objects will be apparent to those skilled in the art.

### BRIEF DESCRIPTION OF THE DRAWINGS

FIG. 1 is a perspective view illustrating the primary work platform stowed at one side of the main boom of an aerial lift and with the jib boom attached to the outer end of the innermost boom section with the outer end of the jib boom having a secondary work platform secured thereto;

FIG. 2 is a side view of the aerial lift of this invention with the broken lines illustrating the manner in which the main boom is pivotally movable with respect to the pedestal;

FIG. 3 is a side view of the outer end of the main boom wherein the primary work platform is an operative position and the jib boom is in a stowed position;

FIG. 4 is a view similar to FIG. 3 except that the primary work platform has been pivotally moved 90° from the position of FIG. 3 and with the broken lines illustrating the primary work platform in a stowed position at one side of the main boom and the jib boom in its stowed position at the other side of the main boom;

FIG. 5 is a top view of the structure shown on FIG. 4;

FIG. 6 is a top view illustrating the primary work platform in its stowed position and the mounting apparatus on the outer end of the main boom being pivotally moved for attachment to the jib boom which is shown in its stowed position; and

FIG. 7 is a perspective view illustrating the manner in which the mounting apparatus is connected to the end of the jib boom with the jib boom being moved from its stowed position.

### DETAILED DESCRIPTION OF THE INVENTION

The aerial lift of this invention is referred to generally by the reference numeral 10 which is mounted on a self-propelled vehicle 12 such as a truck or the like. Aerial lift 10 includes a conventionally horizontally rotatable pedestal 14 having a conventional telescoping boom assembly 16 pivotally secured, about a horizontal axis, to the pedestal 14. Boom assembly 16 includes an outer boom 18 having at least one, and normally a plurality of, inner boom sections 20 which are telescopically received within outer boom 18. For purposes of description, the innermost boom member will be identified with the reference numeral 22.

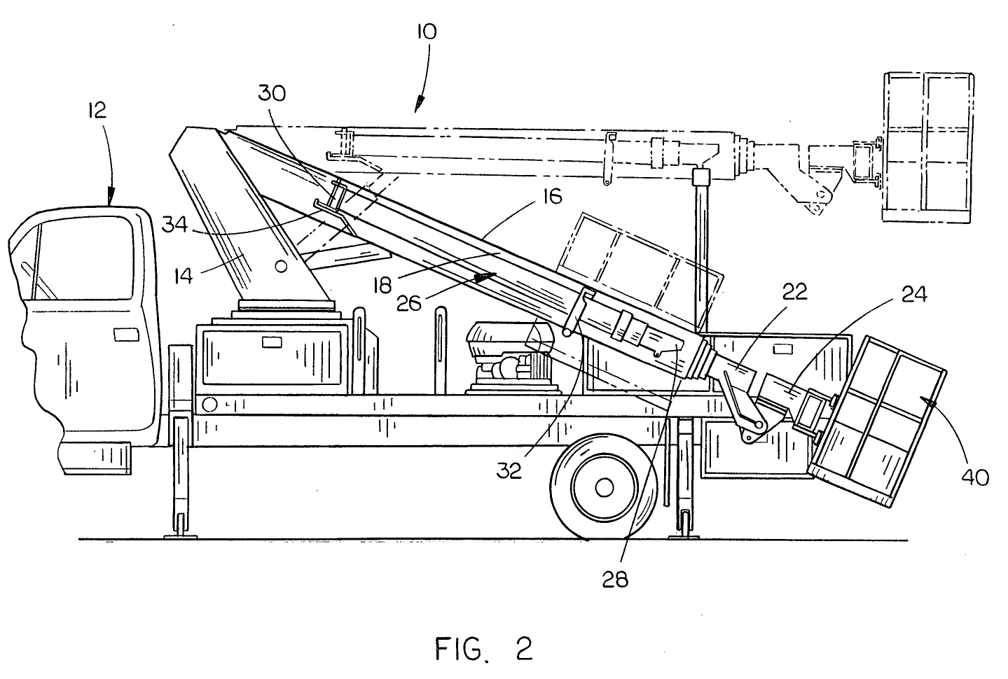

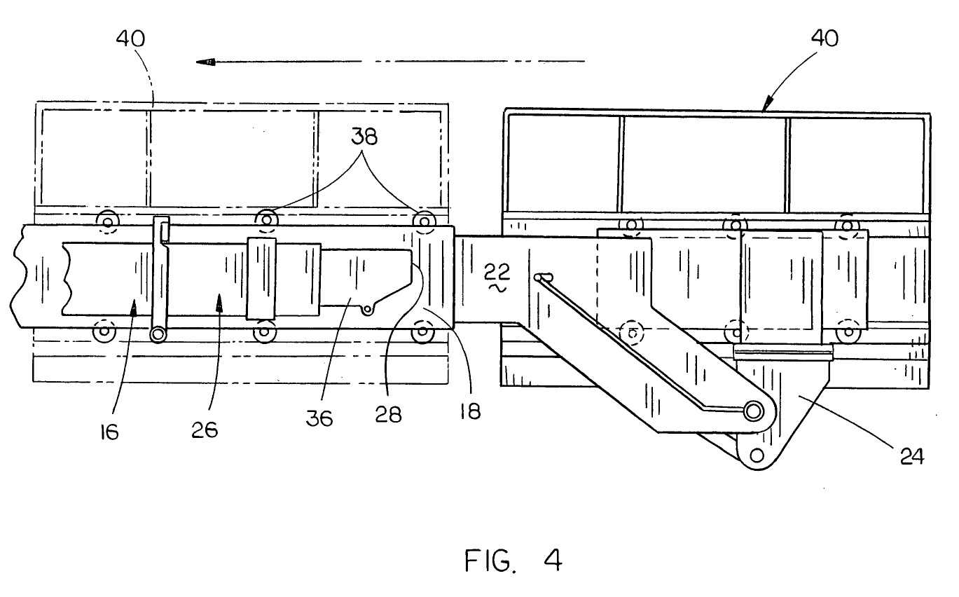

Inner boom member 22 has a mounting apparatus 24 provided thereon which is rotatable about horizontal and vertical axes with respect thereto. The numeral 26 refers to a jib boom having an inner end 28 and outer end 30. FIGS. 2, 3, 4, 5 and 6 illustrate the jib boom 26 in its stowed position adjacent one side of the outer boom section 18 and supported upon spaced-apart connector-supports 32 and 34 which extend from the one side of the outer boom section 18 (FIG. 2). When the jib boom 26 is in the stowed position illustrated in FIGS. 2-6, its outer end 30 is positioned inwardly of its inner end 28. The inner end 28 of jib boom 26 has a connection means 36 provided thereon which is adapted to be secured to the mounting apparatus 24, as will be described in more detail hereinafter.

A plurality of laterally extending supports 38, preferably in the form of rollers, extend laterally from the other side of outer boom section 18 adjacent the outer end thereof. The numeral 40 refers to a first or primary work platform which is selectively removably secured to the mounting apparatus 24. When the work platform 40 is disconnected from the mounting apparatus 24, the work platform 40 may be stowed upon the laterally extending supports 38 and secured to the outer boom section 18 in any conventional fashion.

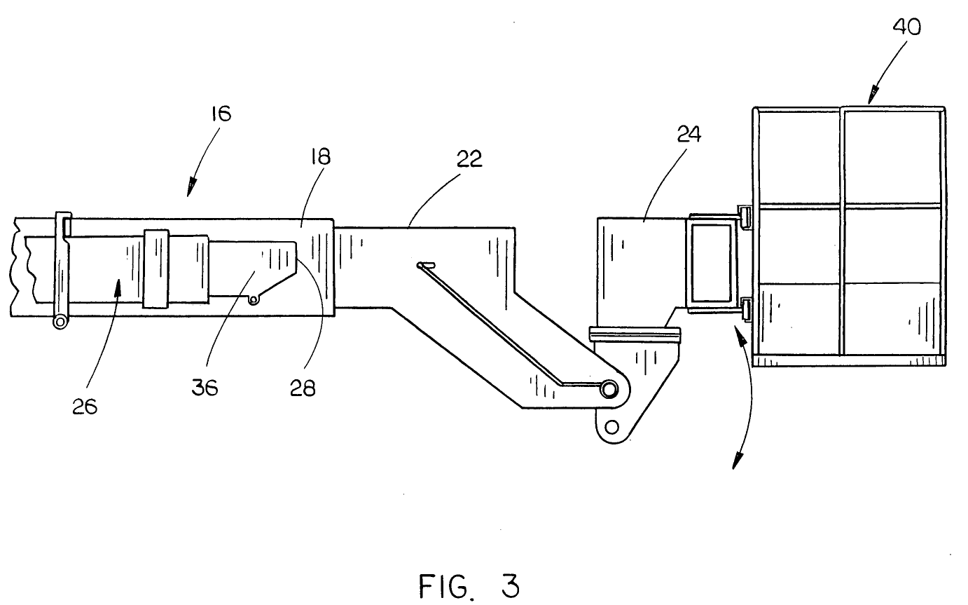

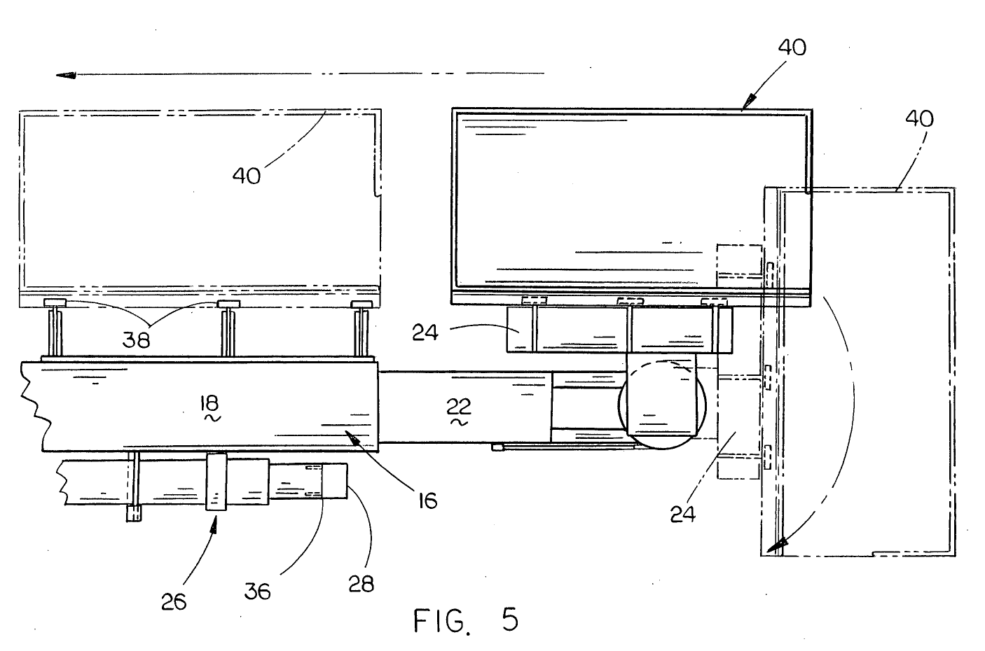

In normal operation, the work platform 40 is secured to the mounting apparatus 24 so as to be pivotally mounted about a horizontal axis and a vertical axis with respect to the boom assembly 16. At that time, the jib boom 26 will be in its stowed position illustrated in FIG. 3. When it is desired to use the jib boom 26 rather than the work platform 40, the mounting apparatus 24 is pivotally moved with respect to boom assembly 16 so that the work platform 40 will be in alignment with the supports 38, as seen in FIG. 5. The mounting apparatus 24 is maneuvered by retraction of one or more of the inner boom sections 20 so that the work platform 40 may be positioned on the laterally extending supports 38 when disconnected from the mounting apparatus 24. The work platform is then secured in its stowed position at one side of the outer boom section 18, as illustrated by broken lines in FIG. 5.

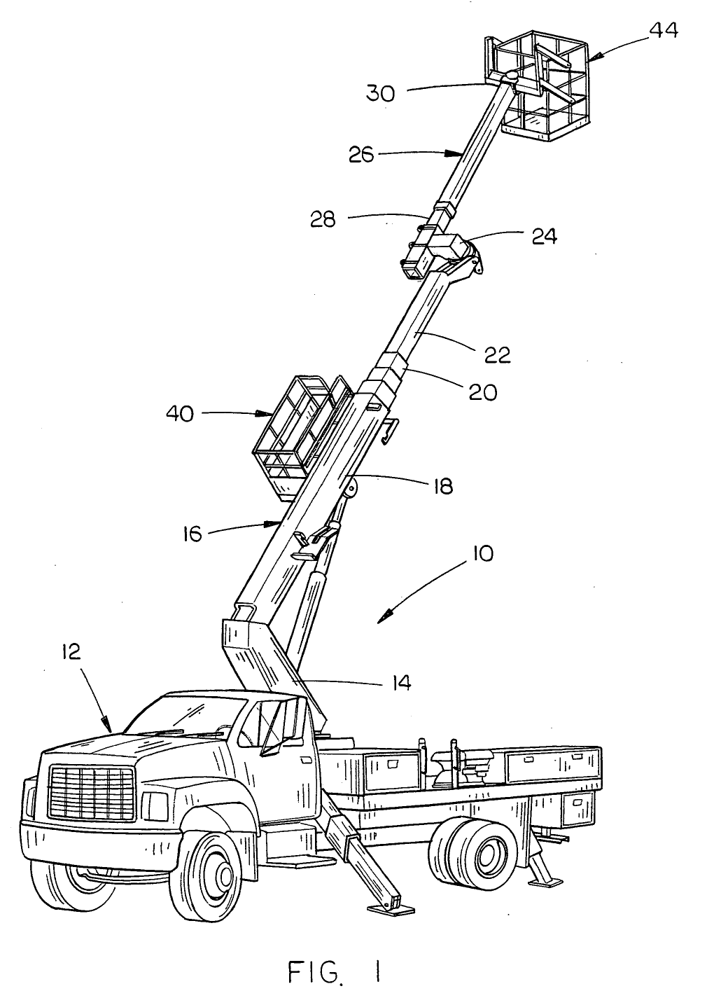

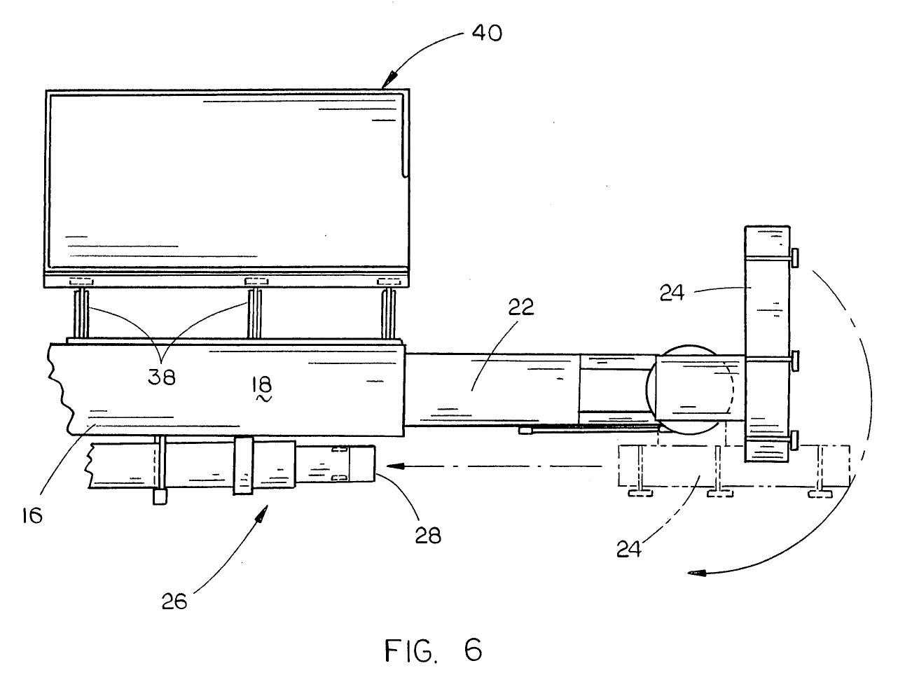

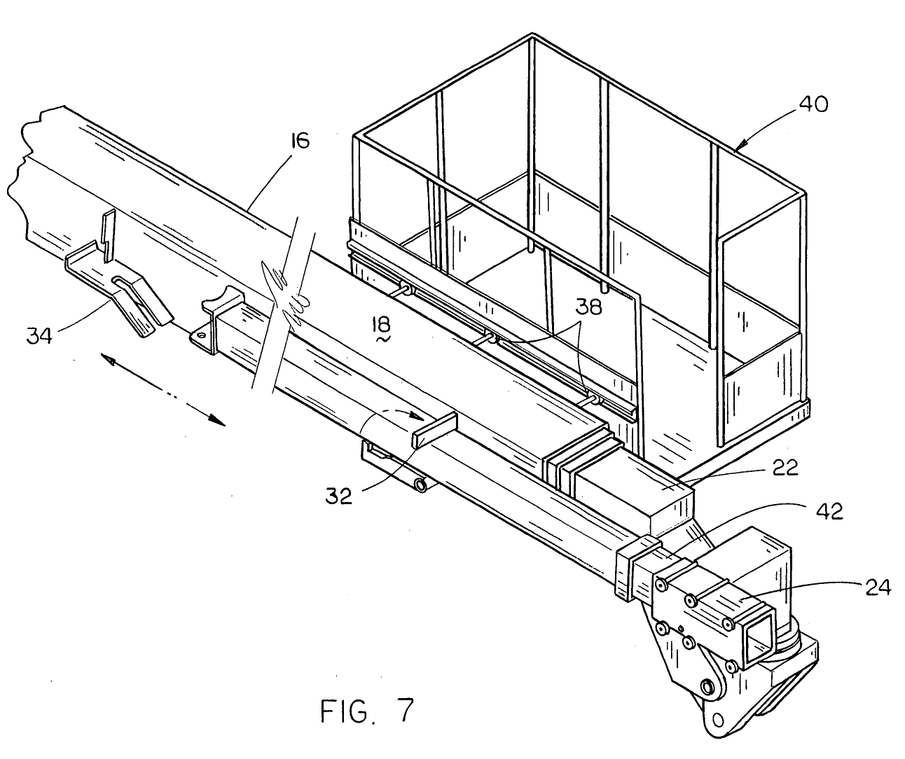

The mounting apparatus 24 is then pivotally moved to the other side of the outer boom section 18, as illustrated by broken lines in FIG. 6, so that the projecting nose or support 42 of mounting apparatus 24 is received within the open inner end of the jib boom 26 and secured thereto (FIG. 7). Connector support 34 is then released and the inner boom section 20 is extended with respect to the other boom sections so that the jib boom 26 is moved away from support 32. When the jib boom 26 has cleared its supports, the mounting apparatus 24 is pivotally moved to swing the jib boom 26 into a position wherein it extends outwardly from the outer end of the inner boom member 22 in a parallel relationship thereto (FIG. 1). If a pulley or sheave is provided on the outer end of the jib boom 26, a winch cable or hoisting cable may be extended thereover. If it is desired to mount another work platform on the outer end of the jib boom 26, while the work platform is stowed at one side of outer boom 18, the boom assembly 16 is maneuvered so that the outer end of the jib boom 26 is aligned with a second work platform 44. The outer end of the jib boom 26 and the inner end of the second work platform 44 will have mutually engagable connectors provided thereon to enable the work platform 44 to be secured thereto.

When it is desired to again use the work platform 40, the work platform 44 will be disconnected from the jib boom 26 and placed on the ground. The mounting apparatus 24 is then pivotally moved so that the jib boom is in alignment with the supports 32 and 34. When the jib boom 26 is supported on the supports 32 and 34, the mounting apparatus 24 is disconnected from the inner end 28 of the jib boom 26 with the mounting apparatus 24 then being pivotally moved towards the other side of the outer boom section 16 so that the mounting apparatus 24 may be connected to the work platform 40. When the connection has been achieved, the mounting apparatus 24 is pivotally moved with respect to the boom assembly so that the work platform 40 is positioned in its desired working position.

Thus it can be seen that a novel aerial platform has been provided which enables a jib boom to be stowed at one side of the main boom and which enables a work platform to be stowed at the other side of the main boom as needed.

Thus it can be seen that the invention accomplishes at least all of its stated objectives.

I claim:

1. An aerial lift, comprising:
a self-propelled vehicle having forward and rearward ends;
a pedestal rotatably mounted, about a vertical axis, on said vehicle;
a telescoping boom structure including an elongated outer boom section with at least one elongated inner boom section telescopically received thereby;
said outer boom section having first and second sides, an inner end and an outer end;
said inner boom section having an inner end and an outer end;
a first mounting apparatus on said outer end of said inner boom section;
said first mounting apparatus being pivotally movable, about a first horizontal axis transverse to the longitudinal axis of said inner boom section;
said first mounting apparatus also being pivotally movable about a second axis which is disposed transversely with respect to said first axis;
a first work platform adapted to be selectively removably secured to said first mounting apparatus for movement therewith;
an elongated jib boom, having inner and outer ends, adapted to be selectively removably positioned and secured in a stowed position at said first side of said outer boom with said inner end thereof being positioned adjacent said outer end of said outer boom section and said outer end of said jib boom being positioned forwardly of said inner end thereof when in the stowed position;
said inner end of said jib boom adapted to be selectively secured to said first mounting apparatus;
said first mounting apparatus being selectively movable with respect to said inner boom section when said first work platform is secured thereto to permit said first work platform to be positioned at said second side of said outer boom section so that said first work platform may be disconnected from said first mounting apparatus, moved towards said inner end of said outer boom section, and stowed at said second side of said outer boom section;
said first mounting apparatus also being selectively movable with respect to said inner boom section when said first work platform is disconnected from said first mounting apparatus to permit said first mounting apparatus to be positioned adjacent said inner end of said jib boom, when in its stowed position, for connection therewith so that said jib boom may be pivotally moved from its stowed position so as to be extended from said outer end of said inner boom section.

2. The aerial lift of claim 1 wherein said outer end of said jib boom has structure associated therewith for connection to a second work platform.

3. The aerial lift of claim 1 wherein said jib boom is tubular and wherein said first mounting apparatus includes a tubular member projecting therefrom which is receivable by said inner end of said jib boom.
